(19) United States
(12) Patent Application Publication
(10) Pub. No.: US 2007/0182884 A1
(43) Pub. Date: Aug. 9, 2007

(54) Backlight module and liquid crystal display device incorporating the same

(75) Inventors: Chun-Yen Lin, Banciao City (TW); Ying Szutu, Taichung (TW)

Correspondence Address: BACON & THOMAS, PLLC, 625 SLATERS LANE, FOURTH FLOOR, ALEXANDRIA, VA, 22314, US

(73) Assignee: AU OPTRONICS CORP., Hsin-Chu (TW)

(21) Appl. No.: 11/503,240

(22) Filed: Aug. 14, 2006

(30) Foreign Application Priority Data
Feb. 9, 2006 (TW) 95104403

(51) Int. Cl. G02F 1/1335

(52) U.S. Cl. 349/65

(57) ABSTRACT

A backlight module and a liquid crystal display device incorporating the same are provided. The backlight module includes a bezel, a light source and a heat dissipation element. The bezel has an opening. The light source is disposed on the bezel. The heat generation portion of the light source corresponds to the opening. One end of the heat dissipation element is positioned between the bezel and the light source. The other end of the heat dissipation element has a protrusion portion which is inserted into the opening and projected outside the bezel. The lateral surface of the protrusion portion is abutted against the inner wall of the opening.

This application claims the benefit of Taiwan Patent Application Serial No. 95104403, filed Feb. 9, 2006, the subject matter of which is incorporated herein by reference.

### BACKGROUND OF THE INVENTION

1. Field of the Invention

The invention relates in general to a backlight module and a liquid crystal display device incorporating the same, and more particularly to a backlight module, which has a heat dissipation element passing through and projected outside the bezel, and a liquid crystal display device incorporating the same.

2. Description of the Related Art

Along with the advance in the manufacturing technology of liquid crystal display (LCD) device devices and further due to the features of slimness, lightweight, low energy consumption and no radiation, LCD devices have been widely applied in various electronic products such as personal digital assistant (PDA), notebook computer, digital camera, digital video recorder, mobile phone, computer monitor, and liquid crystal TV. And further with large amount of input in research and development and the adoption of large-scaled production facilities, the quality of LCD devices continue to increase yet the prices keep falling down. Consequently, the application of LCD devices grows wider and wider. However, the LCD panel of an LCD device is a not a self-luminous display panel, and can not display without being availed by the light provided by a backlight module.

Conventional backlight module includes a bezel, a reflector, a number of lamps, a diffuser and an optical film module. The reflector is disposed on the bezel. The lamps are arranged above the reflector. The diffuser is disposed above the cold cathode fluorescent lamps (CCFLs). The optical film module is disposed above the diffuser. The optical film module includes a prism, a diffuser or a brightness enhancement film. When assembled with the backlight module, the liquid crystal display panel is disposed above the optical film.

Since the lamp is a high-temperature thermal source, the lamp emits both the light and the heat when a starting voltage is applied to the lamp. Besides, the lamp is enclosed inside the backlight module, so the heat generated by the lamp is unable to be dissipated effectively. As a result, the internal temperature of the backlight module is increased. Furthermore, the lamp generates better luminance efficiency when the temperature of the work environment is within a particular range (65˜75° C. for example). Therefore, the luminance efficiency of the lamp tends to deteriorate in a high-temperature work environment. Thus, the luminance of the backlight module is largely reduced, and the operation quality of the liquid crystal display device is severely affected.

Particularly, when the scale of the liquid crystal display device and the scale of the backlight module are getting larger and larger, the lamp needs to be longer and the starting voltage of the lamp becomes larger and larger. Consequently, while the temperature inside the backlight module grows higher and higher, the luminance efficiency of the lamp is deteriorated, and the operation quality of the liquid crystal display device is decreased.

### SUMMARY OF THE INVENTION

It is therefore an object of the invention to provide a backlight module and a liquid crystal display device incorporating the same. The design of enabling the heat dissipation element to pass through the bezel and be projected outside the bezel effectively dissipates the heat generated inside the light source of the backlight module, so that the internal temperature of the backlight module is decreased. Thus, the luminance efficiency of the light source is improved, the luminance of the backlight module is enhanced, and operation quality of the liquid crystal display device is maintained.

The invention achieves the above-identified object by providing a backlight module. The backlight module includes a bezel, a light source and a heat dissipation element. The bezel has at least one opening. The light source is disposed on the bezel. The heat generation portion of the light source corresponds to the opening. One end of the heat dissipation element is positioned between the bezel and the light source. The other end of the heat dissipation element has a protrusion portion, which is inserted into the opening and projected outside the bezel.

The invention achieves the above-identified object by providing a liquid crystal display device. The liquid crystal display device includes a backlight module, a first polarizer, a second polarizer and a liquid crystal display panel. The backlight module includes a bezel, a light source and a heat dissipation element. The bezel has at least one opening. The light source is disposed on the bezel. The heat generation portion of the light source corresponds to the opening. One end of the heat dissipation element is positioned between the bezel and the light source. The other end of the heat dissipation element has a protrusion portion, which is inserted into the opening and projected outside the bezel. The lateral surface of the protrusion portion is abutted against the inner wall of the opening. The first polarizer and the second polarizer are disposed above the backlight module. The liquid crystal display panel is disposed between the first polarizer and the second polarizer.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A schematically illustrates a backlight module according to a first embodiment of the invention;

FIG. 1B illustrates an exploded diagram of a bezel and a heat dissipation element of FIG. 1A;

FIG. 2A schematically illustrates a backlight module according to a second embodiment of the invention;

FIG. 2B illustrates an exploded diagram of a bezel and a heat dissipation element of FIG. 2A;

FIG. 3A schematically illustrates a backlight module according to a third embodiment of the invention;

FIG. 3B illustrates an exploded diagram of a bezel and a heat dissipation element of FIG. 3A;

FIG. 4A schematically illustrates a backlight module according to a fourth embodiment of the invention;

FIG. 4B illustrates an exploded diagram of a bezel and a heat dissipation element of FIG. 4A;

FIG. 5 schematically illustrates a backlight module according to a fifth embodiment of the invention; and

FIG. 6 illustrates a liquid crystal display device according to a sixth embodiment of the invention.

### DETAILED DESCRIPTION OF THE INVENTION

### First Embodiment

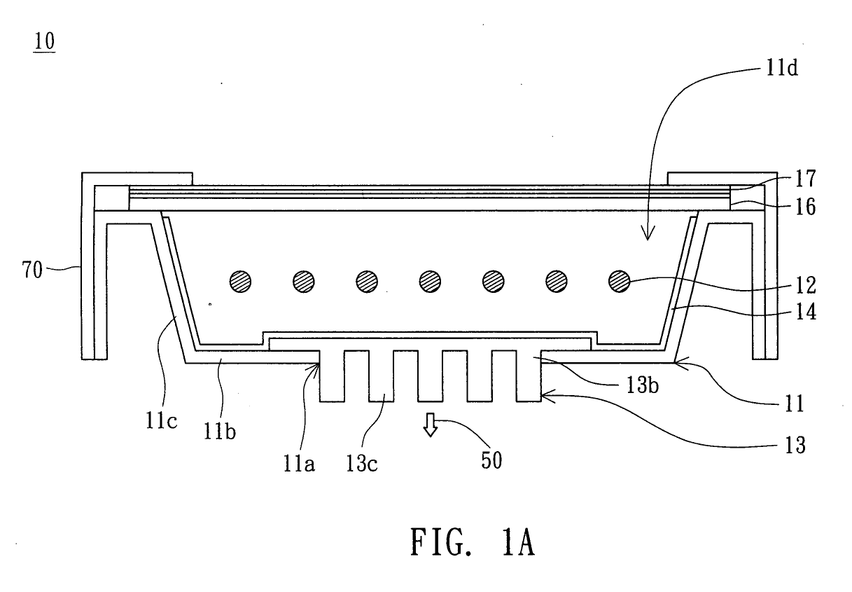

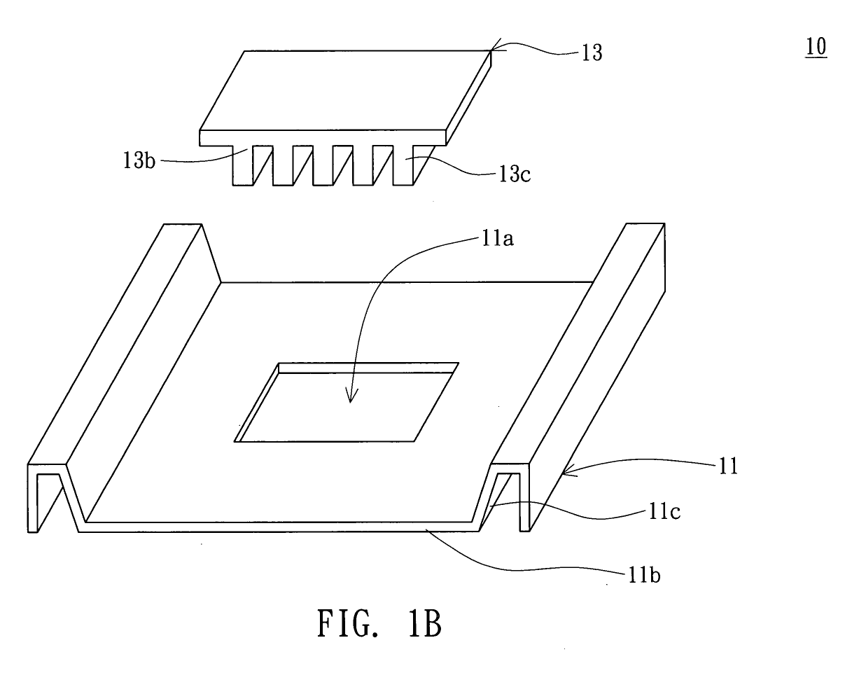

Please refer to FIG. 1A and FIG. 1B at the same time. FIG. 1A schematically illustrates a backlight module according to a first embodiment of the invention. FIG. 1B illustrates an exploded diagram of a bezel and a heat dissipation element of FIG. 1A. As shown in FIG. 1A and FIG. 1B, the backlight module 10 includes a bezel 11, at least a light source 12, and a heat dissipation element 13. The bezel 11 has at least one opening 1a. The light source 12 is disposed above the bezel 11. The heat generation portion of the light source 12 corresponds to the opening 11a. One end of the heat dissipation element 13 is positioned between the bezel 11 and the light source 12. The other end of the heat dissipation element 13 has a protrusion portion 13b. The protrusion portion 13b is inserted into the opening 11a and projected outside the bezel 11. The lateral surface of the protrusion portion 13b is abutted against the inner wall of the opening 11a for enabling the heat dissipation element 13 to be fixed on the bezel 11. The size of the opening 11a must allow the protrusion portion 13b to pass through so that the lateral surface of the protrusion portion 13b is tightly abutted against the inner wall of opening 11a.

In the present embodiment of the invention, the heat dissipation element 13 is abutted against the inner wall of opening 11a and connected to the bezel 11 through the protrusion portion 13b. However, the ways of connection between the heat dissipation element 13 and the bezel 11 is not limited thereto. For example, by ways of screw joint, buckle joint, dowel joint, adhesive joint cup joint, bolt joint or rivet joint, the heat dissipation element 13 can be connected to and pass through the bezel 11 with part of the heat dissipation element 13 being projected outside the bezel 11. Moreover, the heat dissipation element 11 includes high thermo-conductive metal or metallic alloy, the bezel 11 includes metal or metallic alloy, and the heat dissipation element 13 can be thermo-conductively connected to the bezel 11. Examples of the light source 12 include an external electrode fluorescent lamp (EEFL), a cold cathode fluorescent lamp (CCFL), a hot cathode fluorescent lamp (HCFL) or a cold cathode flat fluorescent lamp (CCFFL). In the present embodiment of the invention, the light source 12 is exemplified by a CCFL. The heat generation portion of the light source 12 is an electrode of CCFL for example.

In the relative position between the heat dissipation element 13 and the bezel 11 and the light source 12, the protrusion portion 13b is projected outside the bezel 11 by the way of passing through the opening 11a. The heat dissipation element 13 passes through the bezel 11 and corresponds to the light source 12. During the heat dissipating process of the heat dissipation element 13, firstly, the end of the heat dissipation element 13 closer to the light source 12 directly absorbs the heat generated by the light source 12. Next, the heat dissipation element 13 transmits the absorbed heat to the protrusion portion 13b along the direction of the arrow 50. Then, the heat dissipation element 13 dissipates the heat outwardly at the protrusion portion 13b along the direction of the arrow 50. Thus, the internal temperature of the backlight module 10 is decreased, the luminance efficiency of the light source 12 is increased, and the luminance of the backlight module 10 is enhanced.

The backlight module 10 further includes a reflector 14. The reflector 14 is disposed between the bezel 11 and the light source 12 and covers the heat dissipation element 13. Furthermore, the protrusion portion 13b includes at least a fin 13c (5 fins 13c for example) for increasing the contact area between the heat dissipation element 13 and the external (the air for example) and increasing the dissipation efficiency of the heat dissipation element 13. The number of the fin 13c of the present embodiment of the invention can be increased or decreased according to actual needs.

In the present embodiment of the invention, a heat dissipation element 11 such as a radiating fin with one or multiple fins and of blade or other shapes is coupled to the bezel 11. The heat transmission and dissipation effects of the heat dissipation element 11 are used to absorb the heat generated inside the backlight module 10. Meanwhile, by means of the heat dissipation effect of the radiating fin, the internal heat of the backlight module 10 is dissipated to the outside for maintaining the internal temperature of the backlight module 10 to a range within which the light source 12 has best efficiency in illuminating.

Moreover, the bezel 11 further has a bottom plate 11b and a side plate 11c connected to the bottom plate 11b. An accommodation space 11d is defined by the bottom plate 11b and the side plate 11c. The light source 12 is disposed in the accommodation space 11d. The bottom plate 11b has an opening 11a. The protrusion portion 13b is inserted into the opening 11a and projected outside the bottom plate 11b. The bottom surface of the end of the heat dissipation element 13 closer to the light source 12 contacts the top surface of the bottom plate 11b. On the bottom plate 11b, the reflector 14 is not aligned with the top surface of the bottom plate 11b. However, the reflectivity of the reflector 14 is not affected. The reflector 14 is disposed in the accommodation space 11d and positioned among the bottom plate 11b, the side plate 11c and the light source 12. Part of the reflector 14 covers the heat dissipation element 13.

Any one who is skilled in the technology of the present embodiment of the invention will understand that the technology the present embodiment of the invention is not limited thereto. For example, the reflector 14 is spread over or adhered onto the bottom plate 11b and the side plate 11c of the bezel 11. Besides, the backlight module 10 further includes a diffuser 16 and an optical film module 17. The diffuser 16 is disposed above the light source 12 and covers the opening at the top end of the accommodation space 11d. Furthermore, the optical film module 17 is disposed above the diffuser 16. The optical film module 17 includes a prism, a diffuser or a brightness enhancement film. After the first frame 70 is coupled with the bezel 11, the optical film module 17 and the diffuser 16 can be disposed above the bezel 11 and the light source 12.

Despite in the present embodiment of the invention, the heat dissipation element 11 corresponds to the light source 12, however, the technology of the present embodiment of the invention is not limited thereto. For example, with regards to the distribution of the internal temperature of the backlight module 10, a heat dissipation element can be disposed in the region of the backlight module 10 where the internal temperature is high and the heat is intensified. The heat dissipation element still passes through the bezel 11, and part of the heat dissipation element is projected outside the bezel 11, so that the heat of the high-temperature region of the backlight module 10 is dissipated more efficiently.

According to the present embodiment of the invention, the heat dissipation element 13 passes through the bezel 11 and is projected outside the bezel 11, hence effectively dissipating the internal heat of the backlight module 10 to the outside and achieving the object of reducing the internal temperature of the backlight module 10. Thus, the luminance efficiency of the light source 12 is increased and the luminance of the backlight module 10 is enhanced.

### Second Embodiment

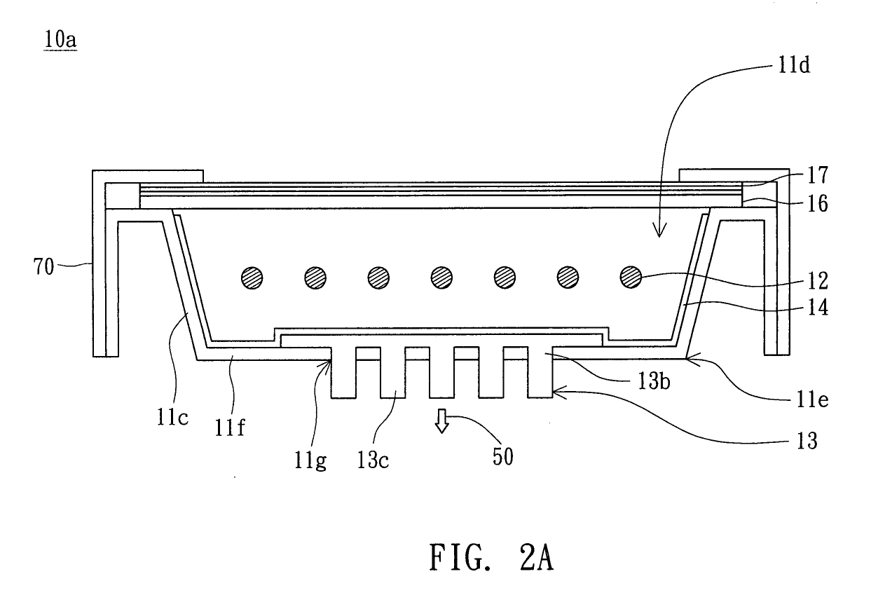

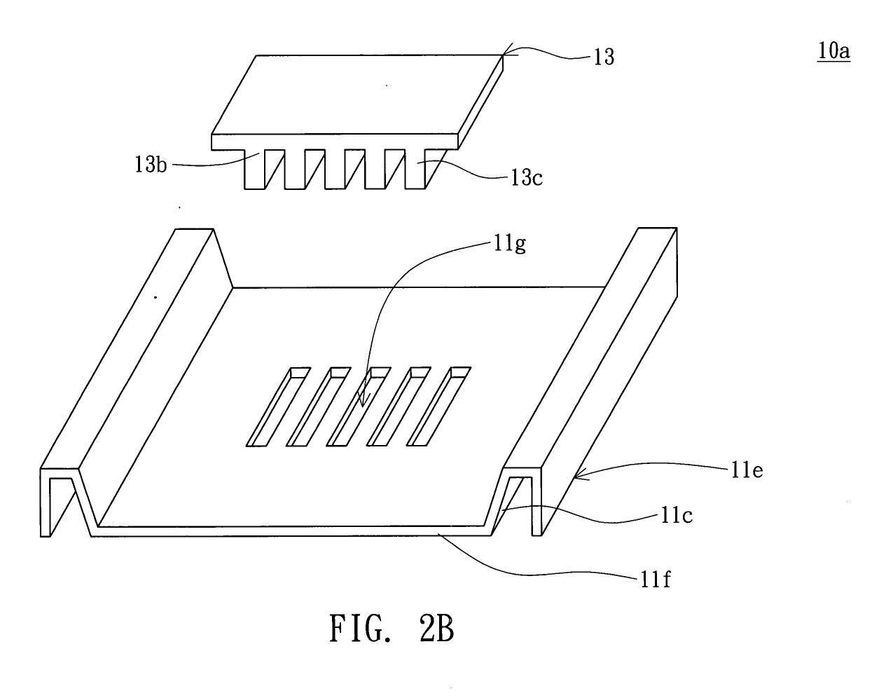

Please refer to FIG. 2A and FIG. 2B at the same time. FIG. 2A schematically illustrates a backlight module according to a second embodiment of the invention. FIG. 2B illustrates an exploded diagram of a bezel and a heat dissipation element of FIG. 2A. The backlight module 10a of the present embodiment of the invention differs with the backlight module 10 of the first embodiment in the bezel 11e. The bezel 11e of the present embodiment of the invention differs with the bezel 11 of the first embodiment in the bottom plate 11f. The bottom plate 11f of the present embodiment of the invention differs with the bottom plate 11b of the first embodiment in a number of openings 11g positioned opposite to the fins 13c. As for other similar elements, the same reference labels are used and their connections are not repeated here.

As shown in FIG. 2A and FIG. 2B, each fin 13c is inserted into its corresponding opening 11g and projected outside the bottom plate 11f of the bezel 11e. The lateral surface of each fin 13c is abutted against the inner wall of corresponding opening 11g for fixing the heat dissipation element 13 on the bezel 11e. The size of the opening 11g must allow the fin 13c of the heat dissipation element 13 to pass through so that the lateral surface of the fin 13c is tightly abutted against the inner wall of the opening 11g.

### Third Embodiment

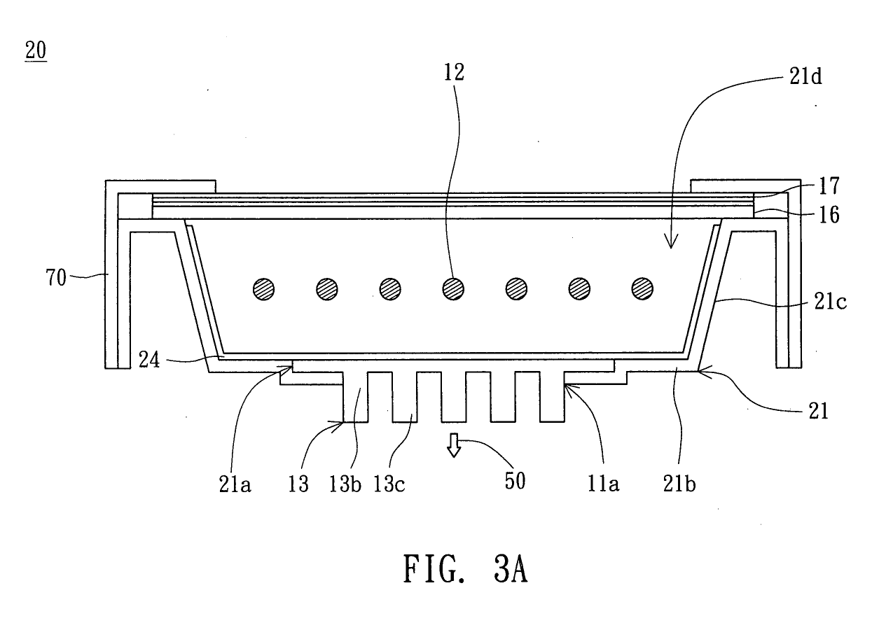

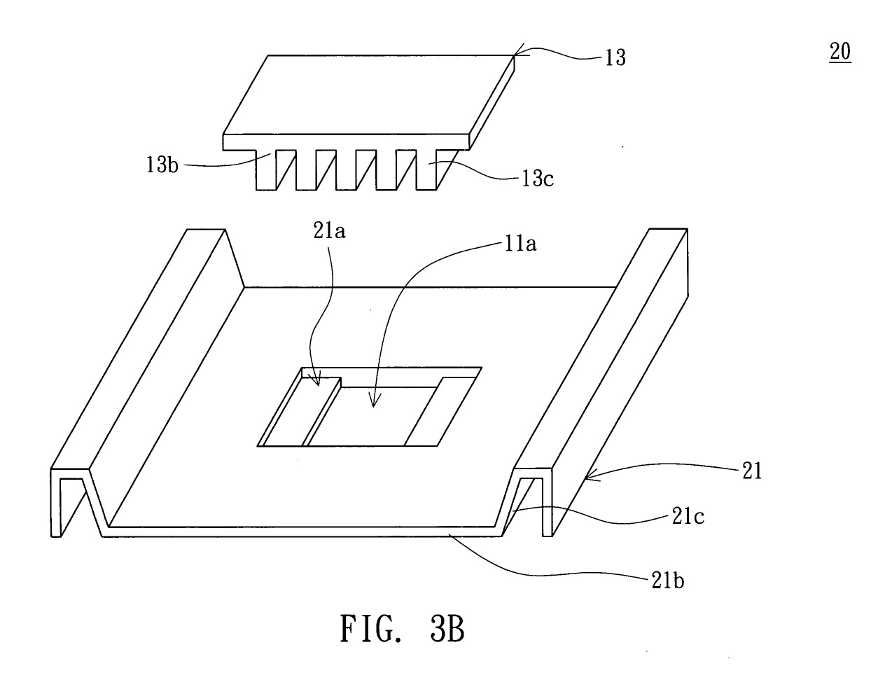

Referring to FIG. 3A and FIG. 3B at the same time. FIG. 3A schematically illustrates a backlight module according to a third embodiment of the invention. FIG. 3B illustrates an exploded diagram of a bezel and a heat dissipation element of FIG. 3A. The backlight module 20 of the present embodiment of the invention differs with the backlight module 10 of the first embodiment in the bezel 21 and the reflector 24. As for other similar elements, the same reference labels are used and their connections are not repeated here.

As shown in FIG. 3A and FIG. 3B, the bezel 21 has a bottom plate 21b and a side plate 21c connected to the bottom plate 21b. An accommodation space 21d is defined by the bottom plate 21b and the side plate 21c. The light source 12 is disposed in the accommodation space 21d. The bottom plate 21b has a recess 21a. The bottom of the recess 21a has an opening 11a. One end of the heat dissipation element 13 is positioned in recess 21a. The protrusion portion 13b of the other end of the heat dissipation element 13 is inserted into the opening 11a and projected outside the bottom of the recess 21a. The lateral surface of the protrusion portion 13b is abutted against the inner wall of the opening 11a for fixing the heat dissipation element 13 on the bezel 21. The reflector 24 is disposed in the accommodation space 21d and positioned among the bottom plate 21b, the side plate 21c and the light source 12. Part of the reflector 24 covers the heat dissipation element 13 and the recess 21a. The bottom surface of the end of the heat dissipation element 13 positioned in the recess 21a contacts the top surface of the bottom of the recess 21a. On the bottom plate 21b, the reflector 24 is aligned with the top surface of the bottom plate 21b and the top surface of the end of the heat dissipation element 13 positioned in the recess 21a.

### Fourth Embodiment

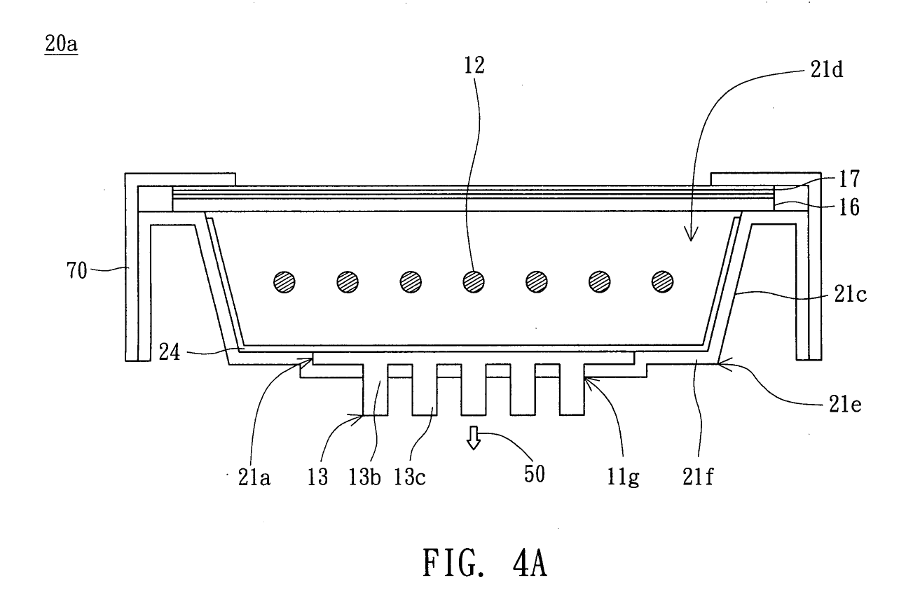

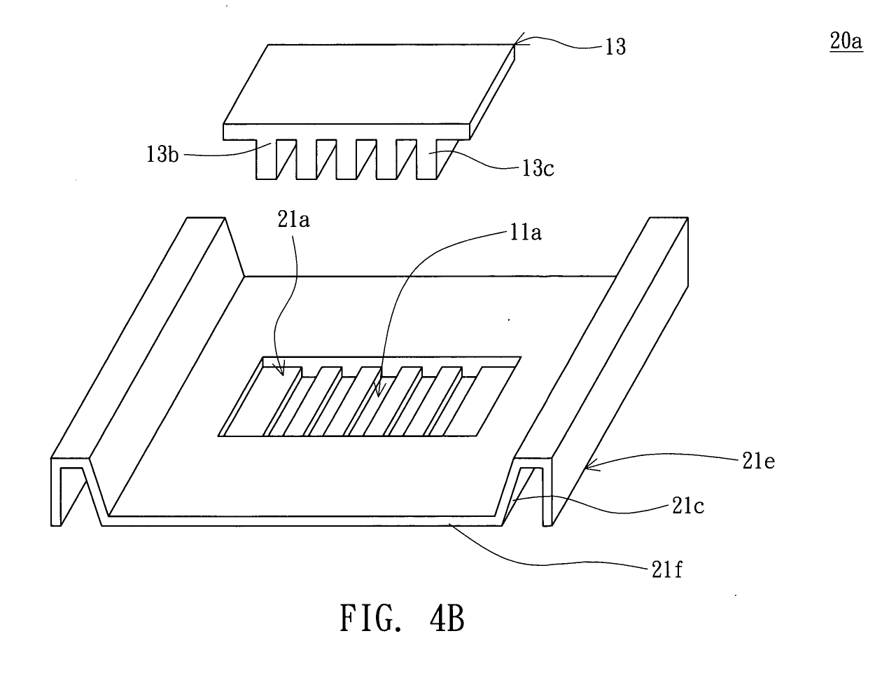

Please refer to FIG. 4A and FIG. 4B. FIG. 4A schematically illustrates a backlight module according to a fourth embodiment of the invention. FIG. 4B illustrates an exploded diagram of a bezel and a heat dissipation element of FIG. 4A. The backlight module 20a of the present embodiment of the invention differs with the backlight module 20 of the third embodiment in the bezel 21e. The bezel 21e of the present embodiment of the invention differs with the bezel 21 of the third embodiment in the bottom plate 21f. The bottom plate 21f of the present embodiment of the invention differs with the bottom plate 21b of the third embodiment in a number of openings 1g positioned opposite to the fin 13c. As for other similar elements, the same reference labels are used and their connections are not repeated here.

As shown in FIG. 4A and FIG. 4B, each fin 13c is inserted into its corresponding opening 11g and projected outside the bottom of the recess 21a. The lateral surface of each fin 13c is abutted against the inner wall of corresponding opening 11g for fixing the heat dissipation element 13 on the bezel 21e. The size of the opening 11g must allow the fin 13c of the heat dissipation element 13 to pass through so that the lateral surface of the fin 13c is tightly abutted against the inner wall of the opening 11g.

### Fifth Embodiment

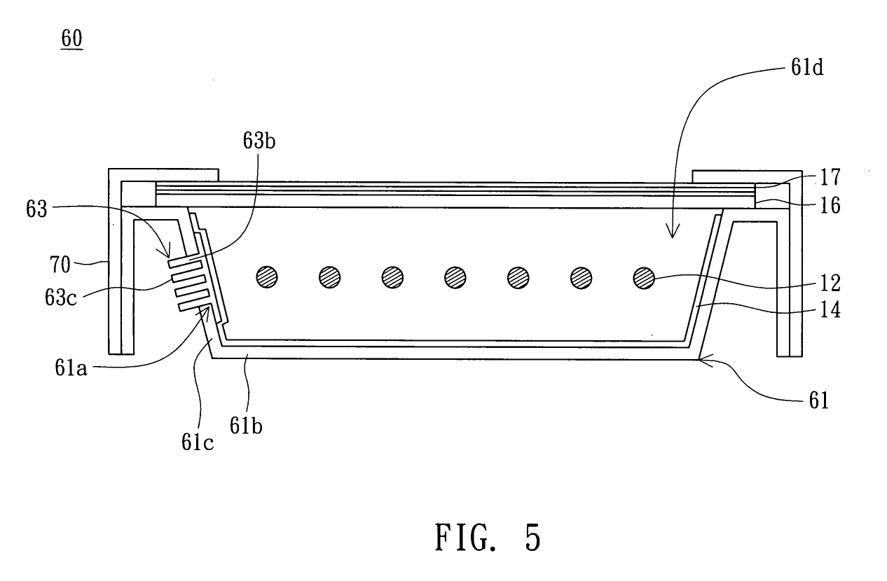

Please refer to FIG. 5. FIG. 5 schematically illustrates a backlight module according to a fifth embodiment of the invention. The backlight module 60 of the present embodiment of the invention differs with the backlight module 10 of the first embodiment in the bezel 61 and heat dissipation element 63. As for other similar elements, the same reference labels are used and their connections are not repeated here.

As shown in FIG. 5, the bezel 61 includes a bottom plate 61b and a side plate 61c connected to the bottom plate 61b. An accommodation space 61d is defined by the bottom plate 61b and the side plate 61c. The light source 12 is disposed in the accommodation space 61d. The side plate 61c has an opening 61a. One end of the heat dissipation element 63 is positioned between the bezel 61 and the light source 12. The other end of the heat dissipation element 63 has a protrusion portion 63b. The protrusion portion 63b is inserted into the opening 61a and projected outside the side plate 61c. The bottom surface of the end of the heat dissipation element 63 closer to the light source 12 contacts the top surface of the side plate 61c. On the side plate 61c, the reflector 14 is not aligned with the top surface of the side plate 61c. However, the reflectivity of the reflector 14 is not affected. The reflector 14 is disposed in the accommodation space 61d and positioned among the bottom plate 61b, the side plate 61c and the light source 12. Part of the reflector 14 covers the heat dissipation element 63.

Furthermore, the protrusion portion 63b includes at least a fin 63c (5 fins 63c for example) for increasing the contact area between the heat dissipation element 63 and the external (the air for example) and increasing the dissipation efficiency of the heat dissipation element 63. The number of the fin 63c of the present embodiment of the invention can be increased or decreased according to actual needs.

### Sixth Embodiment

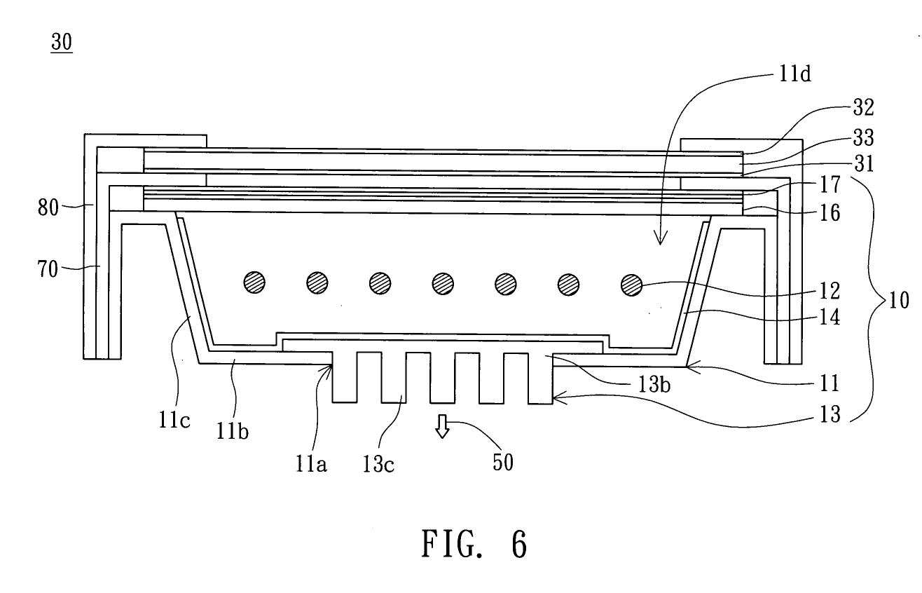

Referring to FIG. 6, a liquid crystal display device according to a sixth embodiment of the invention is shown. As shown in FIG. 6, the liquid crystal display device 30 includes the backlight module 10, 10a, 20, 20a or 60 of above embodiments, a first polarizer 31, a second polarizer 32, and a liquid crystal display panel 33. The present embodiment of the invention is exemplified by the backlight module 10. The first polarizer 31 and the second polarizer 32 are disposed above the backlight module 10. The liquid crystal display panel 33 is disposed between the first polarizer 31 and the second polarizer 32. After the first frame 70 is coupled with the second frame 80, the liquid crystal display panel 33, the first polarizer 31 and the second polarizer 32 can be disposed above the backlight module 10. Besides, the light-transmission line of the first polarizer 31 is substantially perpendicular to the light-transmission line of the second polarizer 32. Furthermore, the liquid crystal display device 30 can be applied in electronic products such as computer monitor, flat TV, monitor, pocket PC TV, mobile phone, handheld game device, digital camera (DC), digital video (DV), digital audio device, personal digital assistant (PDA), webpad, notebook, palm-top computer, lap-top computer, Table PC.

According to the backlight module the liquid crystal display device disclosed in the above embodiments of the invention, the heat dissipation element passes through the bezel and is projected outside the bezel, so that the heat generated by the light source of the backlight module is dissipated to the outside and that the internal temperature of the backlight module is reduced. Thus, the luminance efficiency of the light source is increased, the luminance of the backlight module is enhanced, and the operation quality of the liquid crystal display device is maintained.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A backlight module, comprising:
a bezel having at least one opening;
a light source disposed above the bezel, wherein the heat generation portion of the light source corresponds to the opening; and
a heat dissipation element, wherein one end of the heat dissipation element is positioned between the bezel and the light source, the other end of the heat dissipation element has a protrusion portion which is inserted into the opening and projected outside the bezel.

2. The backlight module according to claim 1, further comprising:
a reflector disposed between the bezel and the light source.

3. The backlight module according to claim 1, wherein the bezel further has a bottom plate and a side plate, an accommodation space is defined by the bottom plate and the side plate, the light source is disposed in the accommodation space, the bottom plate has the opening, and the protrusion portion is inserted into the opening and projected outside the bottom plate.

4. The backlight module according to claim 3, further comprising:
a reflector disposed in the accommodation space and positioned among the bottom plate, the side plate and the light source.

5. The backlight module according to claim 1, wherein the bezel further has a bottom plate and a side plate, an accommodation space is defined by the bottom plate and the side plate, the light source is disposed in the accommodation space, the bottom plate has a recess, the recess has the opening, and the protrusion portion is inserted into the opening and projected outside the bottom of the recess.

6. The backlight module according to claim 5, further comprising:
a reflector disposed in the accommodation space and positioned among the bottom plate, the side plate and the light source.

7. The backlight module according to claim 1, wherein the bezel has the plurality of openings, and the protrusion portion comprises a plurality of fins correspondingly inserted into the openings and projected outside the bezel.

8. The backlight module according to claim 1, wherein the protrusion portion comprises a plurality of fins inserted into the opening and projected outside the bezel.

9. The backlight module according to claim 1, wherein the heat dissipation element includes metal or metallic alloy.

10. The backlight module according to claim 1, wherein the bezel further has a bottom plate and a side plate, an accommodation space is defined by the bottom plate and the side plate, the light source is disposed in the accommodation space, the side plate has the opening, and the protrusion portion is inserted into the opening and projected outside the side plate.

11. A liquid crystal display device, comprising:
a backlight module, comprising:
a bezel having at least one opening;
a light source disposed above the bezel, wherein the heat generation portion of the light source corresponds to the opening; and
a heat dissipation element, wherein one end of the heat dissipation element is positioned between the bezel and the light source, the other end of the heat dissipation element has a protrusion portion, and the protrusion portion is inserted into the opening and projected outside the bezel;
a first polarizer and a second polarizer both disposed above the backlight module; and
a liquid crystal display panel disposed between the first polarizer and the second polarizer.

12. The liquid crystal display device according to claim 11, wherein the backlight module further comprises:
a reflector disposed between the bezel and the light source.

13. The liquid crystal display device according to claim 11, wherein the bezel further has a bottom plate and a side plate, an accommodation space is defined by the bottom plate and the side plate, the light source is disposed in the accommodation space, the bottom plate has the opening, and the protrusion portion is inserted into the opening and projected outside the bottom plate.

14. The liquid crystal display device according to claim 13, wherein the backlight module further comprises:
a reflector disposed in the accommodation space and positioned among the bottom plate, the side plate and the light source.

15. The liquid crystal display device according to claim 11, wherein the bezel further has a bottom plate and a side plate, an accommodation space is defined by the bottom plate and the side plate, the light source is disposed in the accommodation space, the bottom plate has a recess, the recess has the opening, and the protrusion portion is inserted into the opening and projected outside the bottom of the recess.

16. The liquid crystal display device according to claim 15, wherein the backlight module further comprises:
a reflector disposed in the accommodation space and positioned among the bottom plate, the side plate and the light source.

17. The liquid crystal display device according to claim 11, wherein the bezel has the plurality of openings, and the protrusion portion comprises a plurality of fins correspondingly inserted into the openings and projected outside the bezel.

18. The liquid crystal display device according to claim 11, wherein the protrusion portion comprises a plurality of fins inserted into the opening and projected outside the bezel.

19. The liquid crystal display device according to claim 11, wherein the heat dissipation element includes metal or metallic alloy.

20. The liquid crystal display device according to claim 11, wherein the bezel further has a bottom plate and a side plate, an accommodation space is defined by the bottom plate and the side plate, the light source is disposed in the accommodation space, the side plate has the opening, and the protrusion portion is inserted into the opening and projected outside the side plate.
